(19) United States
(12) Patent Application Publication
(10) Pub. No.: US 2008/0160309 A1
(43) Pub. Date: Jul. 3, 2008

(54) Electrically Conductive Fine Particles, Anisotropic Electrically Conductive Material, and Electrically Conductive Connection Method

(76) Inventor: Takashi Kubota, Shiga (JP)

Correspondence Address: Cheng Law Group, PLLC, 1100 17th Street, N.W., Suite 503, Washington, DC, 20036, US

(21) Appl. No.: 11/883,852

(22) PCT Filed: Feb. 3, 2006
(86) PCT No.: PCT/JP2006/001836

§ 371 Date: Aug. 7, 2007

(30) Foreign Application Priority Data
Feb. 9, 2005 (JP) 2005-033497

(51) Int. Cl. B32B 5/16

(52) U.S. Cl. 428/403

(57) ABSTRACT

This invention provides electrically conductive fine particles, which, even when used particularly in plasma display panels, have low connection resistance and is large in current capacity at the time of connection, further can prevent migration upon heating, and can realize high connection reliability, and anisotropic electrically conductive materials using the electrically conductive fine particles and an electrically conductive connection method. The electrically conductive fine particles (1) comprise particles (2) and films formed by electroless plating on the surface of the particles, that is, a nickel plating film (3), a tin plating film (4), and a bismuth plating film (5) provided in that order, and a silver plating film (6) provided on the outermost surface. The anisotropic electrically conductive material comprises the above electrically conductive fine particles dispersed in a resin binder. The electrically conductive connection method comprises heating the above electrically conductive fine particles on the surface of an electrode to cause metal heat diffusion to form a silver-bismuth-tin film and to allow a part of the softened alloy film to flow on the surface of the electrode, thereby increasing the contact area.

### TECHNICAL FIELD

The present invention relates to electrically conductive fine particles, an anisotropic electrically conductive material, and an electrically conductive connection method, and particularly, to electrically conductive fine particles that have low connection resistance and large current capacity upon connection, and that can prevent migration by heating to thus have high connection reliability, and an anisotropic electrically conductive material and an electrically conductive connection method using the electrically conductive fine particles.

### BACKGROUND ART

Electrically conductive fine particles are widely used as a main constituent material of anisotropic electrically conductive materials such as an anisotropic electrically conductive film, an anisotropic electrically conductive paste and an anisotropic electrically conductive curable pressure-sensitive adhesive, by, for example, mixing the fine particles with a binder resin or the like. These anisotropic electrically conductive materials are sandwiched between substrates or electrode terminals which are opposing to each other, in order to electrically connect the substrates to each other or to electrically connect a small component such as a semiconductor element to the substrate in electronic devices such as a liquid-crystal display, a personal computer and a mobile phone.

As such electrically conductive fine particles, those obtained by plating gold on the outside surface of an organic base particle or an inorganic base particle are widely used.

In recent years, downsizing of electronic devices or electrical parts proceeds, and wiring of substrates and the like became complicated, whereby improvement in reliability of connection has become to be an urgent need. Furthermore, since an element or the like to be applied to a plasma display panel recently developed is driven by a large current, an electrically conductive fine particle adaptable to a large current is required. However, since an electrically conductive layer provided by electroless plating on the outside surface of a nonconductive particle, of which base particle is a resin particle or the like, cannot be generally thickened, there has been a problem that current capacity upon connection was low.

On the other hand, as a member for an electrode connection used in a plasma display panel required to be adaptable to a large current, an electrically conductive fine particle of which base particle is a metal particle has been reported (see, for example, Patent Document 1 and Patent Document 2).

Patent Document 1 discloses a method for adhering by pressing an adhesive sheet in which electrically conductive fine particles of nickel particles or gold plating nickel particles are dispersed. In addition, Patent Document 2 discloses a member using electrically conductive fine particles prepared by coating metal powder of which main component is nickel, copper or the like with gold.

However, an electrically conductive fine particle of which base particle is a nickel particle is not sufficient for adaptability to a further large current or for improvement in connection reliability. In addition, when copper, of which resistance value is lower than that of nickel, is used as a base particle, there has been a problem of oxidation or migration of copper. In other words, when immersion gold plating, which is generally used on the surface of a copper metal particle, is made, an alloy film is formed by dispersion as the plating film. And in the case of a gold-copper alloy film thus formed, oxidation or migration of copper could not be sufficiently prevented, since pinhole is formed on the alloy film. In addition, gold is generally used for the outermost surface, to reduce connection resistance value or to stabilize the surface. Since gold is expensive, it has been attempted to use, for example, silver for the outermost surface. There has been, however, a problem that silver can easily migrate.

Furthermore, in recent years when improvement in reliability of a connection becomes an urgent need, a connection between electrode made by thermally compressing an anisotropic electrically connective film (ACF), for example, using electrically conductive fine particles, has not been sometimes sufficient in connection reliability, since an area where the electrically conductive fine particle contacts with the electrodes is generally small. Thus, especially, in order to apply it to a plasma display panel which is driven by a larger current, more improvement in connection reliability is required.

Patent Document 1: Japan Patent Laid-Open No. 11-16502

Patent Document 2: Japan Patent Laid-Open No. 2001

### DISCLOSURE OF THE INVENTION

In view of the above-mentioned present state, an object of the present invention is to provide electrically conductive fine particles that have low connection resistance and large current capacity upon connection even when used especially in a plasma display panel, and that can prevent migration by heating to thus have high connection reliability, and an anisotropic electrically conductive material and an electrically conductive connection method, each using the electrically conductive fine particles.

In order to accomplish the above-mentioned object, according to the invention of claim 1, an electrically conductive fine particle including a particle, and an electrically connective film formed on the surface of the particle by electroless plating, wherein the electrically conductive film has a nickel plating film, a tin plating film and a bismuth plating film formed in this order from the inside to the outside by electroless plating, and wherein the electrically conductive film has a silver plating film on the outermost surface, is provided.

In addition, the invention according to claim 2 provides an anisotropic electrically conductive material, wherein the electrically conductive fine particles according to claim 1 are dispersed in a resin binder.

In addition, the invention according to claim 3 provides an electrically conductive connection method including the steps of heating the electrically conductive fine particles according to claim 1 on the surface of an electrode to cause metal heat diffusion to form a silver-bismuth-tin alloy film, and to allow a part of the softened alloy film to flow on the surface of the electrode, thereby increasing the contact area.

The present invention will be described hereinbelow in detail.

The electrically conductive fine particle of the present invention has a structure in which an electrically conductive film is formed on the surface of a particle as a base particle. In the electrically conductive film, a nickel plating film, a tin plating film and a bismuth plating film are formed in this order by electroless plating, and a silver plating film is formed on the outermost surface.

In other words, for example, as shown in FIG. 1 by means of a schematic sectional view, an electrically conductive fine particle 1 of the present invention has a structure in which a nickel plating film 3, a tin plating film 4 and a bismuth plating film 5 are formed in this order on the surface of a particle 2 as a base particle by electroless plating. In the above-mentioned electrically conductive film, a silver plating film 6 is formed on the further outside of a lamination of the nickel plating film 3, the tin plating film and the bismuth plating film 5. Therefore, the outermost surface is the silver plating film 6.

Here, when a copper metal particle is used as a base particle and each metal plating film is formed on the surface thereof, there can be provided the electrically conductive fine particle having low connection resistance and large current capacity upon connection, and being excellent especially when used in a plasma display panel.

When the electrically conductive fine particle of the present invention is heated, a silver-bismuth-tin alloy film is formed by metal heat diffusion among the tin plating film, the bismuth plating film and the silver plating film. When the above-mentioned alloy film is formed, the electrically conductive fine particle of the present invention can prevent migration.

In general, in a plasma display panel, since a high voltage of about 250 V is applied between terminals, presence of water content and a metal ion between the terminals together with the high voltage causes generation of migration. When the above-mentioned alloy film is formed, no elution of a metal ion occurs and migration is prevented.

It is preferable that the above-mentioned heating is carried out at 120° C. or higher. When the heating is carried out at a temperature lower than 120° C., metal heat diffusion is not liable to occur among the tin plating film, the bismuth plating film and the silver plating film. In addition, the upper limit of the heating is preferably the temperature at which the base particle does not melt or lower. Here, when a copper metal particle is used, it is preferable that the upper limit is 1000° C. or lower.

A method of the above-mentioned heating is not limited specifically. However, a suitable method, for example, is a method of thermal-compression-bonding at 120° C. or higher of an anisotropic electrically conductive material prepared using the electrically conductive fine particles of the present invention, for example, an anisotropic electrically conductive film to an electrode. In general, when electrodes are connected using the anisotropic electrically conductive film, thermal compression bonding is carried out at 120° C. or higher.

When the electrically conductive fine particles of the present invention is heated at the temperature ranging from 120 to 400° C., which temperature range is generally used upon connecting between electrodes using the anisotropic electrically conductive film, a silver-bismuth-tin alloy film is formed by metal heat diffusion among a tin plating film, a bismuth plating film and a silver plating film. Here, when a copper metal particle is used as a base particle, a nickel plating film is provided for preventing metal heat diffusion of tin to copper being a base particle.

In the present invention, confirmation of formation of a silver-bismuth-tin alloy film can be carried out by, for example, X-ray diffraction analysis, energy dispersive X-ray spectroscopy (hereinafter simply referred to as “EDX” in some cases) or the like.

In addition, a method for examining content of the composition of the above-mentioned alloy film can be carried out by, for example, fluorescent X-ray diffraction analysis, EDX or the like.

The anisotropic electrically conductive material of the present invention is a material wherein the electrically conductive fine particles of the present invention are dispersed in a resin binder.

The above-mentioned anisotropic electrically conductive material is not limited specifically as long as the electrically conductive fine particles of the present invention are dispersed in a resin binder. The anisotropic electrically conductive material comprises, for example, an anisotropic electrically conductive paste, an anisotropic electrically conductive ink, an anisotropic electrically conductive curable pressure-sensitive adhesive, an anisotropic electrically conductive film, an anisotropic electrically conductive sheet and the like.

An object to be connected using the above-mentioned anisotropic electrically conductive material includes an electronic component or the like such as a substrate or a semiconductor. An electrode portion is formed respectively on the surface of these objects. For example, when an anisotropic electrically conductive film is used as the anisotropic electrically conductive material of the present invention for connecting electrodes, thermal compression bonding is carried out at 120° C. or higher, as describes above.

The electrically conductive connection method of the present invention is a method wherein metal heat diffusion is caused by heating the electrically conductive fine particle of the present invention on the surface of an electrode to form a silver-bismuth-tin alloy film, and to allow a part of the softened alloy film to flow on the surface of the electrode, thereby increasing the contact area.

According to the electrically conductive connection method of the present invention, the silver-bismuth-tin alloy film is formed due to metal heat diffusion by heating the electrically conductive fine particles of the present invention on the surface of an electrode. Therefore, excellent electrical connection in which migration can be prevented, even when used especially in a plasma display panel, will be provided.

In addition, according to the electrically conductive connection method of the present invention, since the silver-bismuth-tin alloy film is formed by heating, the alloy film can be softened, and a contact area can increase by allowing a part of a softened alloy film to flow on the surface of the electrode. Thus, by increasing the contact area on the electrode, the electrically conductive fine particles can have excellent connection reliability even when used especially in a plasma display panel.

In the electrically conductive connection method of the present invention, a method of heating the electrically conductive fine particles on the surface of the electrode is not specifically limited, but, for example, a method of heating upon thermal compression bonding of an anisotropic electrically connective film to an electrode is preferably used.

It is preferable that the above-mentioned heating is carried out at 120° C. or higher as described for the electrically conductive fine particle of the present invention. When heating is carried out at a temperature lower than 120° C., metal heat diffusion among the tin plating film, the bismuth plating film and the silver plating film is not liable to occur. In addition, as the upper limit of the heating, the temperature of 1000° C. or lower, at which a copper metal particle being a base particle does not melt, is preferable.

According to the electrically conductive connection method of the present invention, a tin-bismuth-silver alloy film is formed by heating electrically conductive fine particles to cause metal heat diffusion. As described above, when the electrically conductive fine particles are heated at the temperature ranging from 120° to 400° C., which is usually used upon connecting between electrodes, for example, using an anisotropic electrically connective film, a tin-bismuth-silver alloy film is formed by metal heat diffusion among the tin plating film, the bismuth plating film and the silver plating film.

The present invention will be described hereinbelow in more detail.

A base particle in the present invention may comprise a resin particle, an inorganic particle, an organic-inorganic hybrid particle, a metal particle and the like. A resin constituting the resin particle includes, for example, a divinylbenzene resin, a styrene resin, an acrylic resin, a urea rein, an imide resin and the like. In addition, an inorganic material constituting the inorganic particle includes silica, carbon black and the like. In addition, the organic-inorganic hybrid particle includes, for example, an organic-inorganic hybrid consisting of a cross-linked alkoxysilyl polymer and an acrylic resin. In addition, the metal particle includes a copper metal, a copper alloy and the like. Among them, it is preferable that the base particle is a copper metal.

Purity of the copper metal particle in the present invention is not specifically limited, but preferably 95% by weight or more, and more preferably 99% by weight or more. When the purity of copper is lower than 95% by weight, for example, when used in a plasma display panel, it may be difficult to ensure connection reliability upon applying a large current.

The shape of the above-mentioned particle is not specifically limited, and may be, for example, a particle having a specific shape such as a spherical, fibrous, hollow or acicular shape, or may be a particle having an amorphous shape. Among them, in order to obtain excellent electrical connection, the particle preferably has a spherical shape.

The average particle size of the above-mentioned particle is preferably, but not limited specifically to, 1 to 100 μm, and more preferably 2 to 20 μm.

In addition, CV value of the above-mentioned particle is preferably, but not limited specifically to, 10% or less, and more preferably 7% or less. Here, CV value is a value obtained by dividing standard deviation in particle size distribution by the average particle size, expressed in percentage.

A commercially available product of the copper metal particle which can meet the requirements of the above-mentioned average particle size and CV value includes, for example, spherical copper powder “SCP-10” manufactured by S-SCIENCE CO., LTD., spherical copper powder “MA-CD-S” manufactured by MITSUI MINING & SMELTING CO., LTD., and the like.

When the base particle is a copper metal particle, upon carrying out electroless plating on the surface of the above-mentioned particle, it is preferable to purify the surface of the copper metal particle until an active surface of metal copper is exposed. A method for purifying the surface of the copper metal particle includes, but not limited specifically to, for example, a wet method using persulfate or the like, a dry method using plasma or the like, and the like. Among them, the wet method is preferably used, since the processing method is convenient.

The thickness of the nickel plating film in the present invention is preferably, but not limited specifically to, 1 to 5% of the average particle size of the particles.

In addition, the thickness of the tin plating film is preferably, but not limited specifically to, 1 to 5% of the average particle size of the particles.

In addition, the thickness of the bismuth plating film is preferably, but not limited specifically to, 1 to 3.5% of the average particle size of the particles.

In addition, the thickness of the silver plating film is preferably, but not limited specifically to, 0.01 to 0.05% of the average particle size of the particles.

In the present invention, as a method for forming a plating film by electroless plating, without limitation, for example, a method of forming a plating film by reducing plating such as a reducing nickel plating film, a reducing tin plating film, a reducing bismuth plating film or a reducing silver plating film, or by immersion tin plating or the like are preferably used.

The method for forming a plating film by the above-mentioned reducing plating may be either a method using autocatalytic reducing plating or a method using substrate-catalyzed reducing plating. Furthermore, the method by autocatalytic reducing plating and the method using substrate-catalyzed reducing plating may be combined.

The above-mentioned method using substrate-catalyzed reducing plating is a method of forming a plating film by allowing presence of a reducing agent which causes an oxidation reaction on the surface of a substrate metal but does not cause an oxidation reaction on the surface of a precipitated metal on the surface of the substrate metal, and by reducing a metal salt for the plating to precipitate.

When the above-mentioned nickel plating film is formed, a nickel salt includes, but not limited specifically to, for example, nickel sulfate, nickel chloride, nickel nitrate and the like.

In addition, when the above-mentioned tin plating film is formed, a tin salt includes, but not limited specifically to, for example, tin chloride, tin nitrate and the like.

In addition, when the above-mentioned bismuth plating film is formed, a bismuth salt includes, but not limited specifically to, for example, bismuth nitrate and the like.

In addition, when the above-mentioned silver plating film is formed, a silver salt includes, but not limited specifically to, for example, silver nitrate, silver chloride, silver cyanide and the like.

Next, a specific method of autocatalytic reducing nickel plating will be explained.

The above-mentioned method using autocatalytic reducing nickel plating is a method wherein palladium metal is first attached as a catalyst, and thereafter a nickel plating film precipitates by autocatalyst.

An autocatalytic reducing nickel plating bath includes, for example, a plating bath prepared by adding carboxylic acid such as citric acid or tartaric acid or aminocarboxylic acid such as glycine as a complexing agent, a phosphorous reducing agent such as sodium hypophosphite or a boron reducing agent such as dimethylamino borane as a reducing agent, monocarboxylic acid such as acetic acid or propionic acid in addition to boric acid as a pH buffer, and a pH adjusting agent to a nickel salt-based plating bath, and the like.

The concentration of the nickel salt in the above-mentioned plating bath is preferably 0.01 to 0.1 mol/l.

The concentration of the citric acid as a complexing agent in the above-mentioned plating bath is preferably 0.08 to 0.8 mol/l.

The concentration of the sodium hypophosphite as a reducing agent in the above-mentioned plating bath is preferably 0.03 to 0.7 mol/l.

The concentration of the pH buffer in the above-mentioned plating bath to suppress pH variation is preferably 0.01 to 0.3 mol/l.

In addition, the pH adjusting agent in the above-mentioned plating bath for adjusting pH includes, for example, when adjusting the pH to alkaline pH, ammonia, sodium hydroxide and the like. Among them, ammonia is preferable. When adjusting the pH to acidic pH, the pH adjusting agent includes sulfuric acid, hydrochloric acid and the like. Among them, sulfuric acid is preferable.

The above-mentioned plating bath should be rather high pH for increasing driving force of the reaction, and is preferably pH 8 to pH 10.

Furthermore, the bath temperature of the above-mentioned plating bath should be rather high for increasing driving force of the reaction, but too high temperature may cause degradation of the bath. Therefore, the temperature of 50° C. to 70° C. is preferable.

In addition, in the above-mentioned plating bath, accumulation caused by the reaction easily occurs when the particles are not dispersed uniformly in an aqueous solution. Therefore, it is preferable to use a dispersion means of at least any of ultrasonic wave and a stirrer.

Next, specific methods of immersion tin plating and autocatalytic reducing tin plating will be explained.

The above-mentioned method using immersion tin plating is a method wherein nickel which is a substrate is dissolved and wherein tin salt accepts the electron of the dissolved nickel salt, to precipitate a tin plating film.

An immersion tin plating bath includes, for example, a plating bath prepared by adding carboxylic acid such as tartaric acid and sulfur compound such as thiourea as a complexing agent to a tin salt-based plating bath, and the like.

The concentration of the tin salt in the above-mentioned plating bath is preferably 0.01 to 0.1 mol/l.

As the complexing agent in the above-mentioned plating bath, the concentration of the tartaric acid is preferably 0.08 to 0.8 mol/l, and the concentration of the thiourea is preferably 0.08 to 0.8 mol/l.

In addition, it is preferable that adjustment of pH, adjustment of bath temperature, and dispersion means of the above-mentioned plating bath are carried out in a similar manner as in the case of the above-mentioned reducing nickel plating bath.

The above-mentioned method using autocatalytic reducing tin plating is a method of forming a tin plating film as an autocatalytic reducing tin plating by a dismutation reaction on the immersed tin plating film.

The reducing tin plating bath as the dismutation reaction includes, for example, a plating bath prepared by adding carboxylic acid such as citric acid or tartaric acid as a complexing agent, sodium hydroxide, potassium hydroxide or the like as a reducing agent, and sodium hydrogenphosphate, ammonium hydrogenphosphate or the like as a buffer to a tin salt-based plating bath, and the like.

The concentration of the tin salt in the above-mentioned plating bath is preferably 0.01 to 0.1 mol/l.

The concentration of the citric acid as a complexing agent in the above-mentioned plating bath is preferably 0.08 to 0.8 mol/l.

The concentration of the sodium hydroxide as a reducing agent in the above-mentioned plating bath is preferably 0.3 to 2.4 mol/l.

The concentration of sodium hydrogenphosphate in the above-mentioned plating bath, which is a buffer to stabilize precipitation of tin, is preferably 0.1 to 0.3 mol/l.

In addition, it is preferable that adjustment of pH, adjustment of bath temperature and dispersion means of the above-mentioned plating bath are carried out in a similar manner as in the case of the above-mentioned reducing nickel plating bath.

Next, a specific method of autocatalytic reducing bismuth plating will be explained.

The above-mentioned method using autocatalytic reducing bismuth plating is a method wherein palladium metal is first attached to a tin plating film, which is a substrate, and thereafter a bismuth plating film precipitates by autocatalyst.

The autocatalytic bismuth plating bath includes, for example, a plating bath prepared by adding carboxylic acid such as sodium citrate as a complexing agent, titanium(III) chloride, titanium(IV) chloride or the like as a reducing agent, glyoxylic acid or the like as a crystal adjustment agent, hydrogenphosphate or the like as a buffer and a pH adjusting agent to a bismuth salt-based plating bath, and the like.

The concentration of the bismuth salt in the above-mentioned plating bath is preferably 0.01 to 0.03 mol/l.

The concentration of the sodium citrate as a complexing agent in the above-mentioned plating bath is preferably 0.04 to 0.1 mol/l.

The concentration of the respective titanium chloride as a reducing agent in the above-mentioned plating bath is preferably 0.12 to 0.8 mol/l.

The concentration of the glyoxylic acid as a crystal adjustment agent in the above-mentioned plating bath is preferably 0.001 to 0.005 mol/l.

The concentration of hydrogenphosphate as a buffer in the above-mentioned plating bath is preferably 0.04 to 0.12 mol/l.

In addition, as the pH adjusting agent in the above-mentioned plating bath for adjusting pH includes, for example, when adjusting the pH to alkaline pH, ammonia and the like. When adjusting the pH to acidic pH, the pH adjusting agent includes sulfuric acid, hydrochloric acid and the like. Among them, sulfuric acid is preferable.

The above-mentioned plating bath should be rather high pH for increasing driving force of the reaction, and is preferably pH 8 to pH 10.

Furthermore, bath temperature of the above-mentioned plating bath is preferably 10° C. to 30° C.

In addition, it is preferable that the dispersion means of the above-mentioned plating bath is carried out in a similar manner as in the case of the above-mentioned reducing nickel plating bath.

Next, a specific method of autocatalytic reducing silver plating will be explained.

An autocatalytic reducing silver plating bath includes, for example, a plating bath prepared by adding carboxylic acid such as succinimide as a complexing agent, an imidazole compound as a reducing agent, glyoxylic acid or the like as a crystal adjustment agent for generating fine crystal, and a pH adjusting agent to a silver salt-based plating bath, and the like.

The concentration of the silver salt in the above-mentioned plating bath is preferably 0.01 to 0.03 mol/l.

The concentration of the succinimide as a complexing agent in the above-mentioned plating bath is preferably 0.04 to 0.1 mol/l.

The concentration of the imidazole compound as a reducing agent in the above-mentioned plating bath is preferably 0.04 to 0.1 mol/l.

The concentration of the glyoxylic acid as a crystal adjustment agent in the above-mentioned plating bath is preferably 0.001 to 0.005 mol/l.

In addition, the pH adjusting agent in the above-mentioned plating bath for adjusting pH includes, for example, when adjusting the pH to alkaline pH, ammonia and the like. When adjusting the pH to acidic pH, the pH adjusting agent includes sulfuric acid, hydrochloric acid and the like. Among them, sulfuric acid is preferable.

The above-mentioned plating bath should be rather high pH for increasing driving force of the reaction, and is preferably pH 8 to pH 10.

Furthermore, bath temperature of the above-mentioned plating bath is preferably 10° C. to 30° C.

In addition, it is preferable that the dispersion means of the above-mentioned plating bath is carried out in a similar manner as in the case of the above-mentioned reducing nickel plating bath.

A method for producing the anisotropic electrically conductive material of the present invention includes, but not limited specifically to, for example, a method wherein the electrically conductive fine particles of the present invention are added to an insulating resin binder and dispersed uniformly by mixing therewith to obtain, for example, an anisotropic electrically conductive paste, an anisotropic electrically conductive ink, an anisotropic electrically conductive curable pressure-sensitive adhesive or the like; a method wherein the electrically conductive fine particles of the present invention are added to an insulating resin binder and mixed therewith uniformly to prepare an electrically conductive composition, and thereafter the resulting electrically conductive composition is, if needed, dissolved (dispersed) uniformly in an organic solvent or heat-melted, then applied to a releasing surface of a releasing material such as a release paper or a release film so as to have a given film thickness, and dried or cooled if needed, to obtain, for example, an anisotropic electrically conductive film, an anisotropic electrically conductive sheet or the like. An appropriate production method can be employed depending on the kind of the anisotropic electrically conductive material to be produced. In addition, an insulating resin binder and the electrically conductive fine particles of the present invention can be separately used without mixing, to give an anisotropic electrically conductive material.

The resin of the above-mentioned insulating rein binder includes, but not limited specifically to, for example, a vinyl resin such as a vinyl acetate resin, a vinyl chloride resin, an acrylic resin and a styrene resin; a thermoplastic resin such as a polyolefin resin, an ethylene-vinyl acetate copolymer and a polyamide resin; a curable resin consisting of an epoxy resin, a urethane resin, a polyimide resin, an unsaturated polyester resin and a curing agent thereof; a thermoplastic block copolymer such as a styrene-butadiene-styrene block copolymer, a styrene-isoprene-styrene block copolymer, and a hydrogen additive thereof; elastomers (rubbers) such as a styrene-butadiene copolymer rubber, a chloroprene rubber and an acrylonitrile-styrene block copolymer rubber; and the like. These resins may be used alone, or two or more kinds of these resins may be combined. In addition, the above-mentioned curable resin may be any curable form such as cold-curable, thermosetting, light-curable, moisture curing and the like.

An insulating resin binder, and, in addition to the electrically conductive fine particle of the present invention, if necessary within a range in which accomplishment of the object of the present invention is not inhibited, one or more kinds of various additive such as, for example, an extender, a flexibilizer (plasticizer), a pressure-sensitivity-improving agent, an antioxidant (anti-aging agent), a heat stabilizer, a light stabilizer, an ultraviolet absorber, a coloring agent, a fire retardant, an organic solvent and the like may be combined in the anisotropic electrically conductive material of the present invention.

Since the electrically conductive fine particle of the present invention is composed of the above-mentioned constitution, even when used especially for a plasma display panel, it is now able to obtain an electrically connection having low connection resistance and large current capacity upon connection, and to prevent migration by heating to thus have high connection reliability.

In addition, the anisotropic electrically conductive material using the electrically conductive fine particle of the present invention and the electrically connective connection method can provide low connection resistance and large current capacity upon connection and, especially when used for a plasma display panel, can prevent migration by heating to thus have high connection reliability.

### BRIEF DESCRIPTION OF DRAWINGS

FIG. 1 is an elevation sectional view schematically showing an example of the electrically conductive fine particle of the present invention.

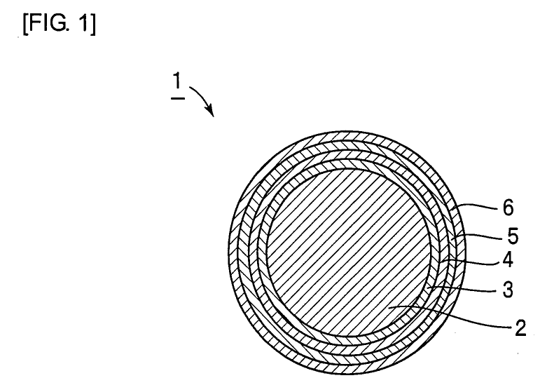

### EXPLANATIONS OF REFERENCE NUMERALS

1 Electrically conductive fine particle
2 Particle
3 Nickel plating film
4 Tin plating film
5 Bismuth plating film
6 Silver plating film

### BEST MODE FOR CARRYING OUT THE INVENTION

The present invention will be explained hereinbelow with reference to examples. Here, the present invention is not to be limited to the following examples.

### Example 1

Copper metal particles having a particle size of 5 μm (purity: 99% by weight) was processed by a wet method wherein the particles were immersed in a mixed solution of hydrogen peroxide and sulfuric acid, to give copper metal particles having a surface exposing copper metal and purified.

Palladium was attached to the resulting copper metal particles by a two-liquid activation method, to give copper metal particles to which palladium was attached.

Next, a solution containing 25 g of nickel sulfate and 1000 ml of ion-exchanged water was prepared, and 10 g of the resulting copper metal particles to which palladium was attached was mixed with the solution, to give an aqueous suspension.

Into the resulting aqueous suspension, 30 g of citric acid, 80 g of sodium hypophosphite, and 10 g of acetic acid were put, to give a plating solution.

The resulting plating solution was adjusted to pH 10 with ammonia and bath temperature was adjusted to 60° C. to react for about 15 to 20 minutes, to give particles on which nickel plating film was formed.

Next, a solution containing 5 g of tin chloride and 1000 ml of ion-exchanged water was prepared, and 15 g of the resulting particles on which a nickel plating film was formed was mixed with the solution, to give an aqueous suspension.

Into the resulting aqueous suspension, 30 g of thiourea and 80 g of tartaric acid was put, to prepare a plating solution.

Bath temperature of the resulting plating solution was adjusted to 60° C. to react for about 15 to 20 minutes, to give particles on which an immersed tin plating film was formed.

Furthermore, 20 g of tin chloride, 40 g of citric acid and 30 g of sodium hydroxide were put into this plating bath. The resultant mixture react at a bath temperature of 60° C. for about 15 to 20 minutes, to give particles on which a tin plating film was formed.

Palladium was attached by a two-liquid activation method, to the resulting particles on which tin plating film was formed, to give particles on which a tin plating film to which palladium was attached was formed.

Next, a solution containing 18 g of bismuth nitrate and 1000 ml of ion-exchanged water was prepared, and 20 g of the resulting particles on which a tin plating film to which palladium was attached was formed was mixed with the solution, to prepare an aqueous suspension.

Into the resulting aqueous suspension, 30 g of sodium citrate, 40 g of titanium(III) chloride, 40 g of titanium(IV) chloride and 40 g of ammonium hydrogenphosphate were put, to prepare a plating solution.

After 5 g of glyoxylic acid was put into the resulting plating solution, the solution was adjusted to pH 10, and the bath temperature was adjusted to 20° C. to react for about 15 to 20 minutes, to give particles on which a bismuth plating film was formed.

Next, a solution containing 5 g of silver nitrate and 1000 ml of ion-exchanged water was prepared, and 24 g of the resulting particles on which a bismuth plating film was formed was mixed with the solution, to prepare an aqueous suspension.

Into the resulting aqueous suspension, 30 g of succinimide, 80 g of imidazole and 5 g of glyoxylic acid were put, to prepare a plating solution.

The resulting plating solution was adjusted to pH 9 with ammonia, and the bath temperature was adjusted to 20° C. to react for about 15 to 20 minutes, to give particles on which a silver plating film was formed. The resulting particles on which a silver plating film was formed were referred to as electrically conductive fine particles.

### Example 2

Electrically conductive fine particles were obtained in a similar manner as in Example 1, except that divinylbenzene resin fine particles having an average particle size of 4 μm were used in place of copper metal particles.

### Comparative Example 1

Copper metal particles of which surface was purified were obtained in a similar manner as in Example 1.

On the resulting copper metal particles of which surface was purified, no nickel plating film, no tin plating film, and no bismuth plating film was formed.

Next, a solution containing 10 g of solver nitrate and 1000 ml of ion-exchanged water was prepared, and 10 g of the resulting copper metal particles of which surface was purified was mixed with the solution, to prepare an aqueous suspension.

Into the resulting aqueous suspension, 30 g of succinimide, 80 g of imidazole and 5 g of glyoxylic acid were put to prepare a plating solution.

The resulting plating solution was adjusted to pH 9 with ammonia, and the bath temperature was adjusted to 60° C. to react for about 15 to 20 minutes, to give particles on which a silver plating film was formed. The resulting particles on which a silver plating film was formed were referred to as electrically conductive fine particles.

(Measurement of Resistance Values of the Electrically Conductive Fine Particles)

For each of the resulting electrically conductive fine particles, resistance values of the electrically conductive fine particles were determined by applying a voltage of 10⁻⁷ V while compressing the electrically conductive fine particles and by determining the resistance value per particle using a micro-compression tester (“DUH-200”, manufactured by SHIMAZU CORPORATION), whereby the resistance value could be determined.

In addition, after PCT test (maintained for 1000 hours in hot and humid atmosphere at 80° C., 95% RH) was conducted, the resistance value of the electrically conductive fine particles was determined in a similar manner to the above manner.

The results are shown in Table 1.

(Evaluation of Leak Current)

Each of the resulting electrically conductive fine particles were added to 100 parts by weight of an epoxy resin (manufactured by Japan Epoxy Resins Co., Ltd., “Epicoat 828”) as a resin for a resin binder, 2 parts by weight of tris(dimethylaminoethyl) phenol, and 100 parts by weight of toluene, and the mixture was mixed thoroughly with a planetary stirrer. Thereafter, a release film was coated with the resulting mixture so as to have a thickness after drying of 7 μm, and toluene was evaporated, to give an adhesive film containing the electrically conductive fine particles. Here, content of the electrically conductive fine particles was set to be 50000/cm³ in the film.

Subsequently, the adhesive film containing the electrically conductive fine particles was bonded to an adhesive film obtained without containing the electrically conductive fine particles at ambient temperature, to give a two-layered anisotropic electrically conductive film having a thickness of 17 μm.

The resulting anisotropic electrically conductive film was cut into a square having a size of 5×5 mm. In addition, two glass substrates were prepared. On these glass substrates, aluminum electrode having at one end a drawing wire portion for measurement of resistance and having a width of 200 μm, a length of 1 mm, a height of 0.2 μm and L/S of 20 μm is formed. After the anisotropic electrically conductive film was attached at almost the center of one of the glass substrate, position of the other glass substrate was adjusted to overlap its electrode pattern with the electrode pattern of the one glass substrate to which the anisotropic electrically conductive film was attached, and then the two substrates were bonded.

After the two glass substrates were thermally compressed under conditions of pressure of 10 N and the temperature of 180° C., presence or absence of leak current between the electrodes was determined for each of the resulting anisotropic electrically conductive film.

In addition, after PCT test (maintained for 1000 hours in heat and humid atmosphere at 80° C. and 95% RH) was conducted, presence or absence of leak current between the electrodes was determined in a similar manner.

The results of the evaluation are shown in Table 1.

Each of the electrically conductive fine particles after thermal compression was taken, and examined for formation of an alloy film with an energy dispersive X-ray spectrometer (manufactured by JOEL DATUM LTD.). As a result, a silver-bismuth-tin alloy film was formed on the electrically conductive fine particles of the Example 1, and no alloy film was formed on the electrically conductive fine particles of Comparative Example 1.

TABLE 1

| | | | | Comparative |
|---|---|---|---|---|
| | | Example 1 | Example 2 | Example 1 |
| Normal | Resistance Value of Electrically | 1.5 × 10⁻⁶ Ω | 1.2 × 10⁻² Ω | 1.5 × 10⁻⁶ Ω |
| | Conductive Fine particles | | | |
| | Presence or Absence of Leak | None | None | None |
| | Current between Electrodes | | | |
| After PCT test | Resistance Value of Electrically | 3.4 × 10⁻⁶ Ω | 7 × 10⁻² Ω | 19.5 × 10⁻⁶ Ω |
| (after 1000 | Conductive Fine particles | | | |
| hours at 80° C., | Presence or Absence of Leak | None | None | Present |
| 95% RH) | Current between Electrodes | | | |

| | | | |
|---|---|---|---|
| Formation of Alloy Film on Electrically | Silver- | Silver- | None |
| Conductive Fine particles after Thermal | Bismuth- | Bismuth- | |
| Compression of Anisotropic Electrically | Tin | Tin | |
| Conductive Film | Alloy Film | Alloy Film | |

As shown in Table 1, the degree of increase in resistance value after PCT test of Examples 1 and 2 is lower and there is no leak current between electrodes, as compared with those of Comparative Example 1. It can be considered that this is because migration of silver occurred in Comparative Example 1, but migration is prevented in Example 1.

Furthermore, adaptability to a large current as used in a plasma display panel was evaluated by turning on electricity by carrying out the following method.

Two ITO glass substrates having a size of 20×40 mm and ITO line width at the connecting portion of 300 μm were prepared. A composition prepared by dispersing 0.5% by weight of each of the resulting electrically conductive fine particles and 1.5% by weight of silica spacer in an epoxy resin (manufactured by Japan Epoxy Resins Co., Ltd., “Epicoat 1009”) as a thermosetting resin was applied onto one of the glass substrates. Thereafter, position of the other glass substrate was adjusted to overlap with the electrode pattern of the one glass substrate and the glass substrates were thermally compressed, to prepare a specimen in a form of ITO/electrically conductive fine particle paste/ITO. It was determined whether the specimen is adaptable to a large voltage by confirming whether or not the electrically conductive fine particles were disrupted by applying a current of 10 mA and a voltage of 100 V.

As a result, since the base particles were copper metal particles both in Example 1 and Comparative Example 1, defective conductivity by disruption of base particles or the like as generated in the electrically conductive fine particles of which base particles are resin particles was not generated. On the other hand, the base particles of the electrically conductive fine particles obtained in Example 2 were disrupted.

### INDUSTRIAL APPLICABILITY

According to the present invention, especially even when used especially for a plasma display panel, an electrically conductive fine particle that have low connection resistance and large current capacity upon connection and that can prevent migration by heating to thus have high connection reliability, as well as an anisotropic electrically conductive material using the electrically conductive fine particles and an electrically conductive connection method can be provided.

1. An electrically conductive fine particle comprising a particle, and an electrically connective film formed on the surface of the particle by electroless plating, wherein said electrically conductive film has a nickel plating film, a tin plating film and a bismuth plating film formed in this order from the inside to the outside by electroless plating, and the electrically conductive film has a silver plating film on the outermost surface.

2. An anisotropic electrically conductive material, wherein the electrically conductive fine particles according to claim 1 are dispersed in a resin binder.

3. An electrically connective connection method, comprising the steps of heating the electrically conductive fine particles according to claim 1 on the surface of an electrode to cause metal heat diffusion to form a silver-bismuth-tin alloy film, and to allow a part of the softened alloy film to flow on the surface of the electrode, thereby increasing a contact area.
